(19) United States
(12) Patent Application Publication
(10) Pub. No.: US 2025/0210850 A1
(43) Pub. Date: Jun. 26, 2025

(54) Electronic Device Antenna with Sheet Metal Cavity

(71) Applicant: Apple Inc., Cupertino, CA (US)

(72) Inventors: Joel D. Barrera, Cedar Park, TX (US); Rhett D. Gentile, San Francisco, CA (US); Menglou Rao, Austin, TX (US); Jerzy S. Guterman, Sunnyvale, CA (US); Daniel D. Hershey, Portland, OR (US)

(21) Appl. No.: 18/391,282

(22) Filed: Dec. 20, 2023

(51) Int. Cl. H01Q 1/22

(52) U.S. Cl. CPC H01Q 1/2266

(57) ABSTRACT

A laptop computer may have a lower housing with an antenna module. The antenna module may include first and second pieces of sheet metal that form a cavity. The cavity may have an aperture covered by a dielectric layer. The first piece of sheet metal may be bent towards the second piece and may be welded to the second piece at a side of the cavity opposite the aperture. An antenna arm may be disposed within the cavity and mounted to the second piece. The antenna arm may be laterally separated from the dielectric layer by a non-zero distance. A dielectric loading block may be disposed within the cavity and mounted to the second piece. The antenna arm may be mounted to a side of the dielectric loading block facing the aperture and the dielectric layer. The antenna arm may convey radio-frequency signals through the aperture and the dielectric layer.

### FIELD

This relates generally to electronic devices, including electronic devices with wireless communications capabilities.

### BACKGROUND

Electronic devices such as portable computers and cellular telephones are often provided with wireless communications capabilities and displays. To satisfy consumer demand for small form factor wireless devices, manufacturers are continually striving to implement wireless communications circuitry such as antenna components using compact structures.

It can be challenging to form electronic device antenna structures with desired attributes. In some wireless devices, the presence of conductive housing structures can impact antenna performance. Device size can also affect performance. It can be difficult to achieve desired performance levels in a compact device, particularly when the compact device has conductive housing structures.

### SUMMARY

An electronic device may have a metal housing. The metal housing may have an upper housing in which a component such as a display is mounted and a lower housing in which a component such as a keyboard is mounted. Hinges may be used to mount the upper housing to the lower housing for rotation about a rotational axis.

An antenna module may be mounted in the lower housing between upper and lower conductive housing walls. The antenna module may include a first piece of sheet metal and a second piece of sheet metal. The first piece of sheet metal may be separated from the second piece of sheet metal by a cavity. The cavity may have an aperture facing a slot between the upper housing and the lower housing. A dielectric layer may cover the aperture. The first piece of sheet metal may be bent towards the second piece of sheet metal and may be welded to the second piece of sheet metal at a side of the cavity opposite the aperture.

The antenna module may include an antenna resonating element. The antenna resonating element may be disposed within the cavity and mounted to the second piece of sheet metal. The antenna resonating element may be orthogonal to a lateral surface of the second piece of sheet metal. The antenna resonating element may be laterally separated from the aperture and the dielectric layer by a non-zero distance. If desired, a dielectric loading block may be disposed within the cavity and mounted to the second piece of sheet metal. The antenna resonating element may be mounted to a side of the dielectric loading block facing the aperture and the dielectric layer. The antenna resonating element may convey radio-frequency signals through the aperture and the dielectric layer.

### BRIEF DESCRIPTION OF THE DRAWINGS

FIG. 1 is a perspective view of an illustrative electronic device such as a laptop computer in accordance with some embodiments.

FIG. 2 is a schematic diagram of an illustrative electronic device with wireless circuitry in accordance with some embodiments.

FIG. 3 is a diagram of an illustrative antenna in accordance with some embodiments.

FIG. 4 is a rear view diagram showing hinge and flexible printed circuit structures bridging a gap between upper and lower housings in a laptop computer of the type shown in FIG. 1 in accordance with some embodiments.

FIG. 5 is an interior perspective view of an illustrative electronic device having an antenna module with a sheet metal cavity in accordance with some embodiments.

FIG. 6 is an interior perspective view of an illustrative antenna module having a sheet metal cavity in accordance with some embodiments.

FIG. 7 is a cross-sectional side view of an illustrative laptop computer showing how an antenna module with a sheet metal cavity may be mounted within a lower housing of the laptop computer in accordance with some embodiments.

FIG. 8 is a perspective view showing how multiple illustrative antenna modules with sheet metal cavities may share the same dielectric cover layer in accordance with some embodiments.

### DETAILED DESCRIPTION

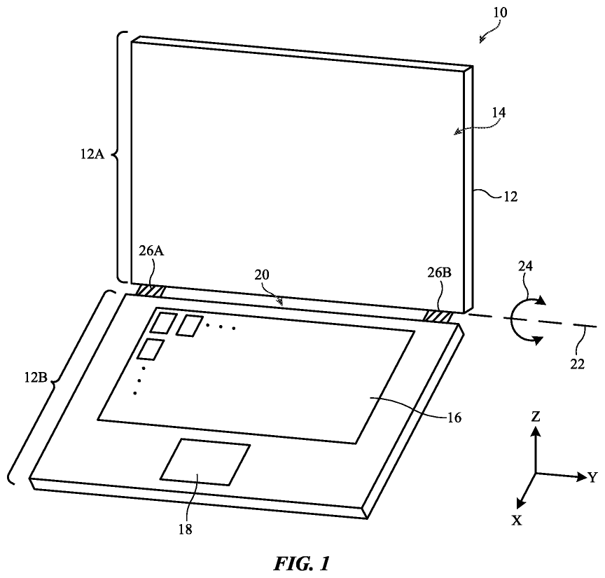

An electronic device such as electronic device 10 of FIG. 1 may contain wireless circuitry. For example, electronic device 10 may contain wireless communications circuitry that operates in long-range communications bands such as cellular telephone bands and wireless circuitry that operates in short-range communications bands such as the 2.4 GHz Bluetooth® or other wireless personal area network (WPAN) bands and the 2.4 GHz and 5 GHz Wi-Fi® band or other wireless local area network (WLAN) bands (sometimes referred to as IEEE 802.11 bands or wireless local area network communications bands). Device 10 may also contain wireless communications circuitry for performing near-field communications, communications at millimeter/centimeter wave frequencies, light-based wireless communications, satellite navigation system communications, or other wireless communications.

Device 10 may be a handheld electronic device such as a cellular telephone, media player, gaming device, or other device, may be a laptop computer, tablet computer, or other portable computer, may be a desktop computer, may be a computer display, may be a display containing an embedded computer, may be a television or set top box, wireless base station, wireless access point, home entertainment console, portable speaker, gaming accessory, wristwatch device, head-mounted display device, or other wearable device, or may be other electronic equipment. Configurations in which device 10 has a rotatable lid as in a portable (e.g., laptop) computer are sometimes described herein as an example. This is, however, merely illustrative. Device 10 may be any suitable electronic equipment.

As shown in the example of FIG. 1, device 10 may have a housing such as housing 12. Housing 12 may be formed from plastic, metal (e.g., aluminum), fiber composites such as carbon fiber, glass, ceramic, other materials, and combinations of these materials. Housing 12 or parts of housing 12 may be formed using a unibody construction in which housing structures are formed from an integrated piece of material. Multipart housing constructions may also be used in which housing 12 or parts of housing 12 are formed from frame structures, housing walls, and other components that are attached to each other using fasteners, adhesive, and other attachment mechanisms.

Some of the structures in housing 12 may be conductive. For example, metal parts of housing 12 such as metal housing walls may be conductive. Other parts of housing 12 may be formed from dielectric material such as plastic, glass, ceramic, non-conducting composites, etc. To ensure that antenna structures in device 10 function properly, care should be taken when placing the antenna structures relative to the conductive portions of housing 12.

If desired, portions of housing 12 may form part of the antenna structures for device 10. For example, conductive housing sidewalls may form all or part of an antenna ground. The antenna ground may include planar portions and/or portions that form one or more cavities for cavity-backed antennas. In addition to portions of housing 12, the cavities in the cavity-backed antennas may be formed from metal brackets, sheet metal members, and other internal metal structures, and/or metal traces on dielectric structures (e.g., plastic structures) in device 10. Metal traces may be formed on dielectric structures using molded interconnect device techniques (e.g., techniques for selectively plating metal traces onto regions of a plastic part that contains multiple shots of plastic with different affinities for metal), using laser direct structuring (LDS) techniques (e.g., techniques in which laser light exposure is used to activate selective portions of a plastic structure for subsequent electroplating metal deposition operations), or using other metal trace deposition and patterning techniques.

As shown in FIG. 1, device 10 may have input-output devices such as track pad 18 (e.g., a touch pad, mouse, other touch-based user input device) and keyboard 16 (e.g., having a set of mechanical and/or electronic-based keys and/or a touch screen display). Device 10 may also have components such as cameras, microphones, speakers, buttons, status indicator lights, buzzers, sensors, and other input-output devices. These devices may be used to gather input for device 10 and may be used to supply a user of device 10 with output. Connector ports in device 10 may receive mating connectors (e.g., an audio plug, a connector associated with a data cable such as a Universal Serial Bus cable, a data cable that handles video and audio data such as a cable that connects device 10 to a computer display, television, or other monitor, etc.).

Device 10 may include a display such a display 14. Display 14 may be a liquid crystal display (LCD), a plasma display, an organic light-emitting diode (OLED) display, an electrophoretic display, or a display implemented using other display technologies. A touch sensor may be incorporated into display 14 (e.g., display 14 may be a touch screen display) or display 14 may be insensitive to touch. Touch sensors for display 14 may be resistive touch sensors, capacitive touch sensors, acoustic touch sensors, light-based touch sensors, force sensors, or touch sensors implemented using other touch technologies.

Device 10 may have a one-piece housing or a multi-piece housing. As shown in FIG. 1, for example, electronic device 10 may be a device such as a portable computer or other device that has a two-part housing formed from an upper housing portion such as upper housing 12A and a lower housing portion such as lower housing 12B. Upper housing 12A may include display 14 and may sometimes be referred to as a display housing or lid. Lower housing 12B may sometimes be referred to as a base housing or main housing.

Housings 12A and 12B may be connected to each other using hinge structures located along the upper edge of lower housing 12B and the lower edge of upper housing 12A. For example, housings 12A and 12B may be coupled by hinges 26 such as hinges 26A and 26B that are located at opposing left and right sides of housing 12 along a rotational axis such as axis 22 (sometimes referred to herein as hinge axis 22). A slot-shaped opening such as opening 20 may be formed between upper housing 12A and lower housing 12B and may be bordered on either end by hinges 26A and 26B. Opening 20 may sometimes be referred to herein as gap 20 or slot 20 between upper housing 12A and lower housing 12B. Hinges 26A and 26B, which may be formed from conductive structures such as metal structures, may allow upper housing 12A to rotate about axis 22 in directions 24 relative to lower housing 12B. Slot 20 extends along the rear edge of lower housing 12B parallel to axis 22. The lateral plane of upper housing (lid) 12A and the lateral plane of lower housing 12B may be separated by an angle that varies between 0° when the lid is closed to 90°, 140°, 160°, or more when the lid is fully opened.

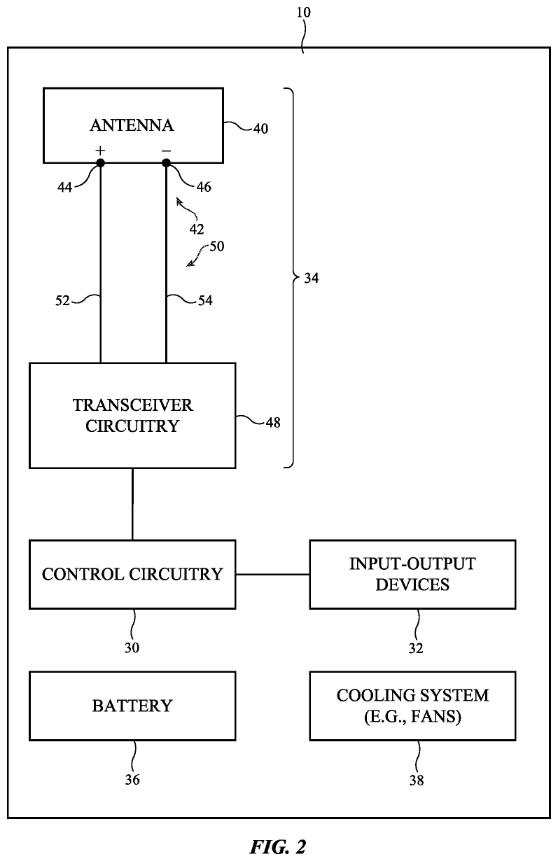

A schematic diagram showing illustrative components that may be used in device 10 is shown in FIG. 2. As shown in FIG. 2, device 10 may include control circuitry such as control circuitry 30. Control circuitry 30 may include storage and/or processing circuitry. Storage in control circuitry 30 may include hard disk drive storage, nonvolatile memory (e.g., flash memory or other electrically-programmable-read-only memory configured to form a solid-state drive), volatile memory (e.g., static or dynamic random-access-memory), etc. Processing circuitry in control circuitry 30 may be used to control the operation of device 10. This processing circuitry may include one or more processors such as microprocessors, microcontrollers, digital signal processors, host processors, baseband processor integrated circuits, application specific integrated circuits, central processing units (CPUs), graphics processing units (GPUs), etc. Control circuitry 30 may be configured to perform operations in device 10 using hardware (e.g., dedicated hardware or circuitry), firmware, and/or software. Software code for performing operations in device 10 may be stored on control circuitry 30 (e.g., storage in control circuitry 30 may include non-transitory (tangible) computer readable storage media that stores the software code). The software code may sometimes be referred to as program instructions, software, data, instructions, or code. Software code stored on the storage may be executed by processing circuitry in control circuitry 30.

Control circuitry 30 may be used to run software on device 10 such as internet browsing applications, voice-over-internet-protocol (VOIP) telephone call applications, email applications, media playback applications, operating system functions, etc. To support interactions with external equipment, control circuitry 30 may be used in implementing communications protocols. Communications protocols that may be implemented using control circuitry 30 include internet protocols, wireless local area network protocols (e.g., IEEE 802.11 protocols-sometimes referred to as WiFi®), protocols for other short-range wireless communications links such as the Bluetooth® protocol or other WPAN protocols, IEEE 802.11ad protocols, cellular telephone protocols, MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), etc. Each communication protocol may be associated with a corresponding radio access technology (RAT) that specifies the physical connection methodology used in implementing the protocol.

Device 10 may include input-output devices 32. Input-output devices 32 may be used to allow data to be supplied to device 10 and to allow data to be provided from device 10 to external devices. Input-output devices 32 may include user interface devices, data port devices, and other input-output components. For example, input-output devices may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, accelerometers, proximity sensors, and other sensors and input-output components.

Device 10 may include wireless communications circuitry 34 that allows control circuitry 30 of device 10 to communicate wirelessly with external equipment. The external equipment with which device 10 communicates wirelessly may be a computer, a cellular telephone, a watch, a router, access point, or other wireless local area network equipment, a wireless base station in a cellular telephone network, a display, a head-mounted device, or other electronic equipment. Wireless communications circuitry 34 may include radio-frequency (RF) transceiver circuitry 48 and one or more antennas such as antenna 40. Configurations in which device 10 contains a single antenna may sometimes be described herein as an example. In general, device 10 may include any number of antennas.

Transceiver circuitry 48 may support communications in Extremely High Frequency (EHF) or millimeter wave communications bands between about 30 GHz and 300 GHz, in centimeter wave communications bands between about 10 GHz and 30 GHZ (sometimes referred to as Super High Frequency (SHF) bands), wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHZ), a cellular midband (MB) (e.g., from 1700 to 2200 MHZ), a cellular high band (HB) (e.g., from 2300 to 2700 MHZ), a cellular ultra-high band (UHB) (e.g., from 3300 to 5000 MHz, or other cellular communications bands between about 600 MHz and about 5000 MHZ (e.g., 3G bands, 4G LTE bands, 5G New Radio Frequency Range 1 (FR1) bands below 10 GHz, etc.), a near-field communications (NFC) band (e.g., at 13.56 MHZ), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands. The communications bands handled by the radio-frequency transceiver circuitry may sometimes be referred to herein as frequency bands or simply as “bands,” and may span corresponding ranges of frequencies. Transceiver circuitry 48 may include one or more integrated circuits, power amplifier circuitry, low-noise input amplifiers, passive radio-frequency components, switching circuitry, transmission line structures, and other circuitry for handling radio-frequency signals.

If desired, device 10 may be supplied with a battery such as battery 36. Control circuitry 30, input-output devices 32, wireless communications circuitry 34, and power management circuitry associated with battery 36 may produce heat during operation. To ensure that these components are cooled satisfactorily, device 10 may be provided with a cooling system such as cooling system 38. Cooling system 38, which may sometimes be referred to as a ventilation system, may include one or more fans and other equipment for removing heat from the components of device 10. Cooling system 38 may include structures that form airflow ports (e.g., openings in ventilation port structures located along slot 20 of FIG. 1 or other portions of device 10 through which cool air may be drawn by one or more cooling fans and through which air that has been warmed from heat produced by internal components may be expelled). Airflow ports, which may sometimes be referred to as cooling ports, ventilation ports, air exhaust and entrance ports, etc., may be formed from arrays of openings in plastic ventilation port structures or other structures associated with cooling system 38.

Radio-frequency transceiver circuitry 48 and antenna(s) 40 may be used to handle one or more radio-frequency communications bands. For example, circuitry 48 may include wireless local area network transceiver circuitry that may handle a 2.4 GHz band for WiFi® and/or Bluetooth® communications and, if desired, may include 5 GHz transceiver circuitry (e.g., for WiFi®). If desired, transceiver circuitry 48 and antenna(s) 40 may handle communications in other bands (e.g., cellular telephone bands, near field communications bands, bands at millimeter wave frequencies, etc.).

Transceiver circuitry 48 may convey radio-frequency signals using one or more antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to free space through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Antennas 40 in wireless circuitry 34 may be formed using any suitable antenna structures. For example, antennas 40 may include antennas with resonating elements that are formed from stacked patch antenna structures, loop antenna structures, patch antenna structures, inverted-F antenna structures, slot antenna structures, planar inverted-F antenna structures, monopole antenna structures, dipole antenna structures, helical antenna structures, Yagi (Yagi-Uda) antenna structures, dielectric resonator antennas, hybrids of these designs, etc. If desired, one or more of antennas 40 may be cavity-backed antennas. Different types of antennas may be used for different bands and combinations of bands. If desired, antennas 40 may be arranged in one or more phased antenna arrays.

As shown in FIG. 2, transceiver circuitry 48 in wireless communications circuitry 34 may be coupled to antennas such as antenna 40 using radio-frequency transmission line paths such as transmission line 50. Transmission line paths in device 10 such as transmission line 50 may include coaxial cables, microstrip transmission lines, stripline transmission lines, edge-coupled microstrip transmission lines, edge-coupled stripline transmission lines, waveguide transmission lines (e.g., coplanar waveguides, grounded coplanar waveguides, etc.), transmission lines formed from combinations of transmission lines of these types, etc.

Transmission line paths in device 10 such as transmission line 50 may be integrated into rigid and/or flexible printed circuit boards if desired. In one suitable arrangement, transmission line paths in device 10 may include transmission line conductors (e.g., signal and/or ground conductors) that are integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive). Filter circuitry, switching circuitry, impedance matching circuitry, and other circuitry may be interposed within the transmission lines, if desired.

Transmission line 50 in device 10 may be coupled to antenna feed 42 of antenna 40. Antenna 40 of FIG. 2 may, for example, form an inverted-F antenna, a planar inverted-F antenna, a slot antenna, a hybrid inverted-F slot antenna or other antenna having an antenna feed such as antenna feed 42 with a positive antenna feed terminal such as positive antenna feed terminal 44 and a ground antenna feed terminal such as ground antenna feed terminal 46. Transmission line 50 may include a positive transmission line conductor 52 (sometimes referred to herein as signal conductor 52) and a ground transmission line conductor 54 (sometimes referred to herein as ground conductor 54). Signal conductor 52 may be coupled to positive antenna feed terminal 44 and ground conductor 54 may be coupled to ground antenna feed terminal 46. Other types of antenna feed arrangements may be used (e.g., indirect feed arrangements, feed arrangements in which antenna 40 is fed using multiple feeds, etc.) and multiple antennas 40 may be provided in device 10, if desired. The feeding configuration of FIG. 2 is merely illustrative.

Filter circuitry, switching circuitry, impedance matching circuitry, and other circuitry may be interposed within transmission line 50, in or between parts of antenna 40, or in other portions of wireless communications circuitry 34, if desired. Control circuitry 30 may be coupled to transceiver circuitry 48 and input-output devices 32. During operation, input-output devices 32 may supply output from device 10 and may receive input from sources that are external to device 10. Control circuitry 30 may use wireless communications circuitry 34 to transmit and receive wireless signals.

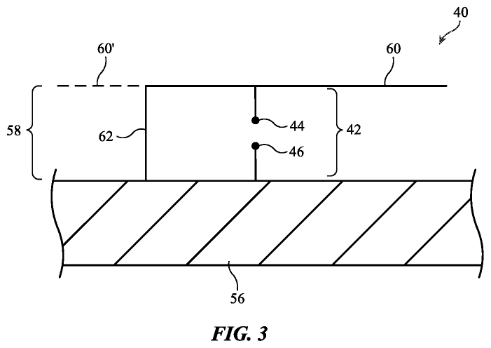

FIG. 3 is a schematic diagram of an illustrative antenna for device 10. In the example of FIG. 3, antenna 40 is an inverted-F antenna having antenna resonating element 58 (e.g., an inverted-F antenna resonating element) and antenna ground 56 (sometimes referred to herein as ground plane 56, ground structures 56, antenna ground structures 56, or ground 56). Antenna resonating element 58 (sometimes referred to herein as antenna radiating element 58, resonating element 58, or radiating element 58) may have one or more antenna resonating element arms such as arm 60 (sometimes also referred to herein as antenna arm 60, radiating arm 60, or resonating arm 60). If desired, antenna resonating element 58 may have multiple branches (e.g., a first branch formed from a first arm 60, a second branch formed from a second arm 60′, etc.). The lengths of each of the arms (branches) of antenna resonating element 58 may be selected to support communications band resonances at desired frequencies (e.g., a high band resonance may be supported using a shorter branch such as second arm 60′ and a low band resonance may be supported using a longer branch such as first arm 60). Second arm 60′ may therefore sometimes be referred to herein as high band arm 60′ and first arm 60 may sometimes be referred to herein as low band arm 60. Antenna resonances may also be produced from resonating element harmonics and/or using parasitic antenna resonating elements.

As shown in FIG. 3, antenna resonating element 58 may be coupled to antenna ground 56 by return path 62. Antenna feed 42 may be coupled between one of the arms 60 of antenna 40 and antenna ground 56 in parallel with return path 62. Positive antenna feed terminal 44 may be coupled to one of the arms 60 of antenna 40. Ground antenna feed terminal 46 may be coupled to antenna ground 56. Antenna ground 56 may be formed from metal portions of housing 12 (e.g., portions of lower housing 12B of FIG. 1), metal traces on a printed circuit or other carrier/substrate, internal metal bracket members, sheet metal members, metal foil, and/or other conductive structures in device 10. This example is merely illustrative and in general, antenna 40 may include an antenna resonating element having any desired shape and architecture and/or may be provided with other structures such as a conductive antenna cavity. The conductive antenna cavity may serve to reflect and/or reshape the radio-frequency signals conveyed by the antenna (e.g., to boost the gain of the antenna). If desired, the conductive antenna cavity may be dimensioned to contribute one or more electromagnetic resonant modes (e.g., cavity modes) to the resonance(s) and/or frequency response of antenna 40 (e.g., the conductive antenna cavity may form a part of antenna resonating element 58 such as in implementations where antenna 40 is a cavity-backed antenna such as a cavity-backed inverted-F antenna).

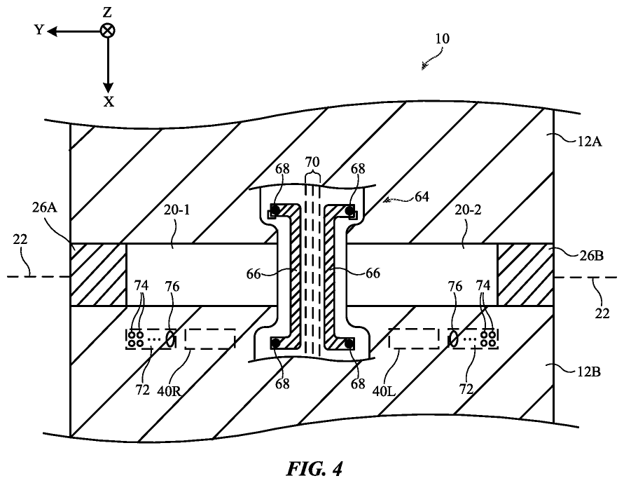

Metal traces on one or more flexible printed circuits may bisect slot 20 of FIG. 1. Consider, for example, the illustrative configuration of device 10 that is shown in FIG. 4 (e.g., a configuration in which upper housing 12A is folded as far open with respect to lower housing 12B about axis 22 such that housings 12A and 12B lie in the same (e.g., X-Y) plane or in nearly the same plane). In the example of FIG. 4, upper housing 12A is separated from lower housing 12B by air-filled slot 20. Hinges 26A and 26B may be coupled between housings 12A and 12B along the respective left and right edges of device 10. One or more flexible printed circuits such as flexible printed circuit 64 may bisect slot 20 along the length of slot 20, thereby creating two slots (i.e., two separate slot-shaped portions of slot 20) such as slots 20-1 and 20-2. Flexible printed circuit 64 may contain one or more sheets of flexible dielectric substrate material such as a layer of polyimide or a sheet of other flexible polymers.

Flexible printed circuit 64 may include signal lines 70 for routing display signals (i.e., data signals associated with displaying images on display 14 of FIG. 1) and other signals (e.g., camera signals, backlight signals, power signals, touch sensor signals, etc.) between upper housing 12A and lower housing 12B. Ground traces 66 may be provided on the outer edges of flexible printed circuit 64 (e.g., in flexible printed circuit 64, signal lines 70 may be flanked on opposing sides by ground traces 66). Ground traces 66 may be formed from copper or other metal and may have any suitable widths (e.g., 1 mm to 3 mm, less than 1 mm, more than 1 mm, etc.). Ground traces 66 may be shorted to metal in housings 12A and 12B using screws, other fasteners, welds, conductive adhesive, solder, or other conductive coupling mechanism (see, e.g., conductive ground connections 68).

With this type of arrangement, slots (openings) 20-1 and 20-2 may be surrounded by metal. For example, slots 20-1 and 20-2 may be surrounded by metal portions of upper housing 12A and lower housing 12B on their top and bottom edges. Hinges 26A and 26B and ground traces 66 may also be formed from metal and may help define the shapes of slots 20-1 and 20-2. As shown in FIG. 4, slot 20-1 may have a left edge formed by hinge 26A and an opposing right edge formed from the ground traces on flexible printed circuit 64. Slot 20-2 may have a left edge formed from flexible printed circuit 64 and an opposing right edge formed from hinge 26-B. The example of FIG. 4 in which one flexible printed circuit divides slot 20 into two separate slots is merely illustrative. If desired, two or more flexible printed circuits may divide slot 20 into three or more separate slots. Two or more separate flexible printed circuits may divide slot 20 into two separate slots 20-1 and 20-2 if desired (e.g., two or more separate flexible printed circuits may be interposed between slots 20-1 and 20-2).

During wireless operation of device 10, slots 20-1 and 20-2 may serve as antenna apertures for respective electrically isolated antennas 40 in lower housing 12B of device 10. For example, a first antenna 40 (e.g., a right antenna 40R) may be mounted within lower housing 12B and aligned with slot 20-1 and a second antenna 40 (e.g., a left antenna 40L) may be mounted within lower housing 12B and aligned with slot 20-2. Conductive structures in lower housing 12B may form cavity structures for each of the antennas 40 (e.g., cavity-shaped ground structures or other ground structures that form part of antenna ground 56 of FIG. 3). By aligning antennas 40 with separate slots between lower housing 12B and upper housing 12A in device 10, the antennas may exhibit sufficient electrical isolation from each other (e.g., such that the antennas may be used to form a multiple-input-multiple-output (MIMO) antenna array at 2.4 GHz and/or 5 GHz and/or other suitable frequencies for wireless local area network communications, etc.).

Device 10 may have speaker structures such as speakers 72 mounted along the rear edge of lower housing 12B or elsewhere in device 10. Speakers 72 may each include a speaker driver, a speaker cavity (e.g., one or more acoustic cavities or chambers that amplify or alter sound waves to optimize the audio response of sound emitted by the speaker), and/or any other components for producing audible sound. Each speaker 72 may include one or more speaker ports 74. Speaker ports 74 may include one or more openings in the conductive material of lower housing 12B that allow sound produced by speakers 72 to escape from the interior of lower housing 12B to be heard by a user.

If desired, additional portions of lower housing 12B may be configured to form supplemental acoustic cavities or chambers for speakers 72 that help to optimize the audio response of speakers 72. As space is at a premium in compact devices such as device 10, portions of other components in lower housing 12B may also be used to form supplemental acoustic cavities or chambers for speakers 72. While each speaker 72 includes a cavity or chamber for emitting sound via speaker ports 74, a portion of the antenna 40 at or adjacent to each speaker 72 may form a supplemental acoustic cavity or chamber for the speaker.

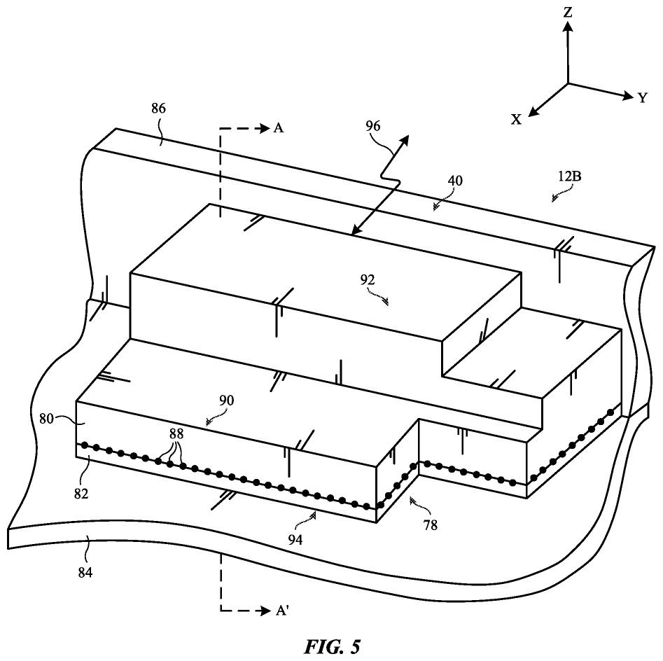

Antennas 40 in lower housing 12B may be integrated within corresponding antenna modules. An antenna module may include a sheet metal cavity for optimizing antenna performance. FIG. 5 is a perspective view of an illustrative antenna module mounted within lower housing 12B of device 10.

As shown in FIG. 5, antenna 40 (e.g., left antenna 40L or right antenna 40R of FIG. 4) may be integrated into an antenna module such as antenna module 78. Antenna module 78 may be mounted to an underlying surface 84 in lower housing 12B. Surface 84 may be the surface of a housing wall, a printed circuit board, a carrier, a package substrate, a plastic substrate, a glass substrate, or any other substrate or structure in lower housing 12B.

Antenna module 78 may have conductive walls formed from at least two joined pieces of sheet metal such as upper sheet metal 80 (sometimes also referred to herein as first sheet metal member 80, a first piece of sheet metal 80, or first sheet metal 80) and lower sheet metal 82 (sometimes also referred to herein as second sheet metal member 82, a second piece of sheet metal 82, or second sheet metal 82). Upper sheet metal 80 may be mounted to lower sheet metal 82. Upper sheet metal 80 may be electrically and mechanically coupled (e.g., connected, secured, attached, affixed, adhered, etc.) to lower sheet metal 82 using welds 88 around the lateral periphery of upper sheet metal 80 and/or lower sheet metal 82 and/or using any other desired conductive interconnect structures (e.g., conductive adhesive, solder, conductive clips, conductive pins, conductive screws, etc.). Upper sheet metal 80 and lower sheet metal 82 are grounded (e.g., held at a ground potential).

Upper sheet metal 80 may be folded or bent about one or more axes. Lower sheet metal 82 or the portion of lower sheet metal 82 overlapping upper sheet metal 80 may be planar or substantially planar. When upper sheet metal 80 is mounted to lower sheet metal 82, a cavity (not shown in FIG. 5 for the sake of clarity) is formed in the space between upper sheet metal 80 and lower sheet metal 82. The cavity may be filled with air and/or other dielectric materials. The cavity has cavity walls (edges) defined by upper sheet metal 80 and lower sheet metal 82. The cavity is sometimes also referred to herein as an antenna cavity or sheet metal cavity.

If desired, the folds in upper sheet metal 80 may configure different portions of upper sheet metal 80 to be vertically separated from lower sheet metal 82 by different distances. For example, upper sheet metal 80 may include at least a first portion 90 (e.g., a first upper wall of the cavity) that is separated from lower sheet metal 82 by a first distance and a second portion 92 (e.g., a second upper wall of the cavity) that is separated from lower sheet metal 82 by a second distance greater than the first distance.

Upper sheet metal 80 may be folded downwards from portions 92 and 90 to lower sheet metal 82 at side 94 of antenna module 78, at the left side of antenna module 78, and at the right side of antenna module 78 (e.g., upper sheet metal 80 may include vertical sidewalls that extend from portions 90 and/or 92 to lower sheet metal 82 at side 94, the left side, and the right side of antenna module 78). However, upper sheet metal 80 does not extend downwards from portion 92 to lower sheet metal 82 at the side of antenna module 78 opposite side 94. As such, antenna module 78 may include an opening, slot, or aperture between upper sheet metal 80 and lower sheet metal 82 at the side of antenna module 78 opposite side 94.

A dielectric layer 86 may be layered onto antenna module 78 and may overlap and cover the opening in antenna module 78 opposite side 94. Dielectric layer 86 may be formed from plastic, ceramic, glass, polymer, and/or other dielectric materials. Antenna 40 may include some or all of an antenna resonating element and an antenna feed disposed within the cavity between upper sheet metal 80 and lower sheet metal 82. Separating portion 92 of upper sheet metal 80 farther from lower sheet metal 82 than portion 90 of upper sheet metal 80 may allow sufficient room to accommodate an antenna resonating element and/or antenna feed within the cavity (e.g., the antenna resonating element and the antenna feed may overlap portion 92 of upper sheet metal 80). The antenna feed (e.g., antenna feed 42 of FIG. 3) may excite the antenna resonating element (e.g., antenna resonating element 58 of FIG. 3) to convey radio-frequency signals 96 through the opening in antenna module 78 opposite side 94 and through dielectric layer 86. Portion 92 may be laterally interposed between portion 90. This may allow placement of the antenna resonating element and/or antenna feed relatively close to dielectric layer 86, thereby optimizing wireless performance.

Since upper sheet metal 80 and lower sheet metal 82 are opaque to radio-frequency signals, radio-frequency signals 96 do not pass through the closed sides of antenna module 78 defined by upper sheet metal 80 and lower sheet metal 82, thereby maximizing the electromagnetic isolation of antenna 40 from other antennas and/or components in device 10. At the same time, upper sheet metal 80 and lower sheet metal 82 may reflect some of the electromagnetic energy of radio-frequency signals 96 towards the opening in antenna module 78 opposite side 94, helping to boost the gain of antenna 40, helping to optimize the radiation pattern of antenna 40, and/or helping to direct radio-frequency signals 96 in a desired direction (e.g., through dielectric layer 86).

If desired, the shape and dimensions of upper sheet metal 80 and lower sheet metal 82 may be selected to provide the cavity between upper sheet metal 80 and lower sheet metal 82 with one or more electromagnetic resonant cavity modes that contribute to the overall radiation and/or frequency response (resonance(s)) of antenna 40 in conveying radio-frequency signals 96 (e.g., upper sheet metal 80 and lower sheet metal 82 may be shaped and dimensioned to provide the cavity with suitable electromagnetic boundary conditions to support one or more fundamental and/or harmonic cavity mode resonances). In these implementations, the cavity may form part of the antenna resonating element for antenna 40 and may be electromagnetically excited by the antenna feed and/or other antenna structures disposed within the cavity (e.g., an antenna resonating element arm or portions of other types of antenna resonating elements).

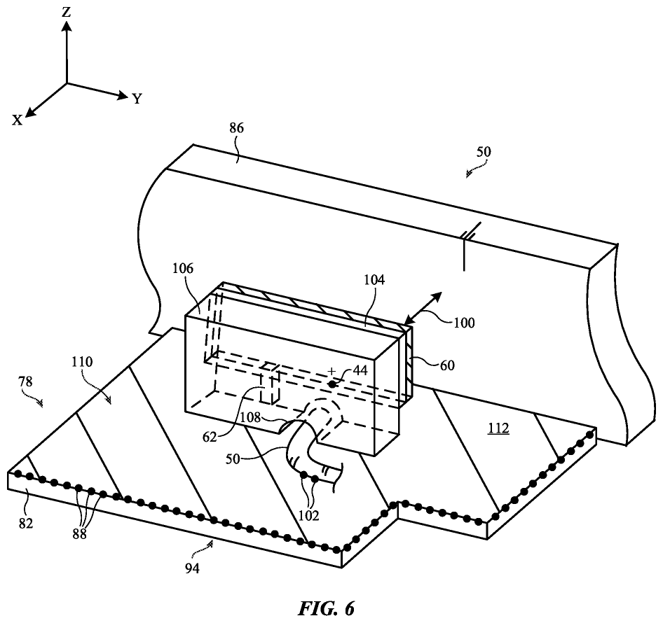

FIG. 6 is an interior perspective view of antenna module 78. In FIG. 6, upper sheet metal 80 has been removed from antenna module 78 and surface 84 has been omitted to more clearly illustrate the antenna structures within antenna module 78.

As shown in FIG. 6, antenna module 78 may include a cavity 112 (e.g., an antenna cavity or sheet metal cavity). Lower sheet metal 82 defines the lower edge, wall, or boundary of cavity 112. The left edge, right edge, rear edge (e.g., side 94), and top edge of cavity 112 are defined by upper sheet metal 80 (FIG. 5) when mounted to lower sheet metal 82. Cavity 112 includes an opening (aperture) at dielectric substrate 86 that is free from sheet metal and welds 88. Welds 88 may help to ensure a continuous electromagnetic connection between upper sheet metal 80 and lower sheet metal 82 at the left, right, and rear sides of antenna module 78, configuring upper sheet metal 80 and lower sheet metal 82 to form a continuous electromagnetic boundary around all sides of cavity 112 except for the aperture at dielectric layer 86.

Antenna 40 may include some or all of an antenna resonating element that is disposed within cavity 112. In the example of FIG. 6, an antenna resonating element arm such as arm 60 (e.g., an inverted-F arm as shown in FIG. 3) is disposed within cavity 112. This is illustrative and non-limiting. If desired, other antenna resonating element structures may be disposed within cavity 112 (e.g., a slot antenna resonating element, a patch antenna resonating element, a monopole antenna resonating element, a dipole antenna resonating element, a planar inverted-F antenna resonating element, etc.). Arm 60 may sometimes also be referred to herein as an excitation element or radiator of antenna 40.

The lateral surface of arm 60 may be oriented perpendicular to lateral surface 110 of lower sheet metal 82 and/or parallel to dielectric layer 86 (e.g., parallel to the Y-Z plane of FIG. 6). This may serve to direct as much of the radiation pattern of arm 60 as possible through the aperture of antenna module 78 and dielectric layer 86, thereby maximizing antenna performance. The lateral surface of arm 60 may also be separated from dielectric layer 86 and the aperture of antenna module 78 by a non-zero distance 100. Distance 100 may be selected to tune and/or optimize the frequency response, efficiency, and/or bandwidth of antenna 40. Antenna 40 may exhibit a more optimal frequency response, efficiency, radiation pattern, and/or bandwidth when arm 60 is separated from dielectric layer 86 by distance 100 than in implementations where arm 60 is pressed or layered against dielectric layer 86. Antenna 40 may exhibit an optimal frequency response, efficiency, and/or bandwidth when distance 100 is 1-3 mm, 1.5-2 mm, or other non-zero distances.

Arm 60 may be mounted to lateral surface 110 of lower sheet metal 82 (e.g., within cavity 112). In implementations where arm 60 is an inverted-F antenna resonating element arm (e.g., as shown in FIGS. 3 and 6), antenna 40 may include a return path 62 that couples arm 60 to lower sheet metal 82. Arm 60 may be fed by a transmission line 50 (e.g., a coaxial cable) that extends into cavity 112. The ground conductor of transmission line 50 may be shorted to lower sheet metal 82 at one or more ground points 102 (e.g., using solder, welds, conductive adhesive, other conductive interconnect structures, etc.). The signal conductor of transmission line 50 may be coupled to arm 60 at positive antenna feed terminal 44.

In some implementations, arm 60 and return path 62 may be formed from conductive traces on an additional substrate such as a laser direct structuring (LDS) plastic block (not shown) or a flexible printed circuit board (not shown) mounted to lower sheet metal 82. The plastic block or flexible printed circuit board may be sufficiently rigid to allow arm 60 to be oriented orthogonal to lateral surface 110. Alternatively, the plastic block or flexible printed circuit board may be provided with a shim or support structure to help hold arm 60 in the upright position.

In other implementations (e.g., as shown in FIG. 6), arm 60 and return path 62 may be formed from integral portions of the same piece of sheet metal (e.g., a piece of sheet metal that is different from upper sheet metal 80 and lower sheet metal 82). In these implementations, return path 62 is rigid and may mount arm 60 to lower sheet metal 82 in a manner that allows arm 60 to be free standing within cavity 112 (e.g., without requiring additional substrates for the antenna to remain in an upright position orthogonal to lateral surface 110).

If desired, arm 60 may be provided with a dielectric loading block such as dielectric loading block 106. Dielectric loading block 106 may be a solid block or layer formed from plastic, ceramic, or other dielectric materials (e.g., having a desired dielectric constant for tuning the response of antenna 40 given its operating frequencies). Dielectric loading block 106 may be mounted to lateral surface 110 of lower sheet metal 82 within cavity 112. Dielectric loading block 106 may be laterally interposed between arm 60 and side 94 of antenna module 78. Put differently, arm 60 may be laterally interposed between dielectric loading block 106 and dielectric layer 86.

If desired, arm 60 may be mechanically attached, secured, or affixed to dielectric loading block 106 (e.g., using a layer of adhesive such as pressure sensitive adhesive 104). This is merely illustrative and, if desired, arm 60 may be spaced apart from dielectric loading block 106 without being mounted to dielectric loading block 106. Dielectric loading block 106 may include one or more openings (tunnels) 108 that extend through the thickness of the block (e.g., parallel to the X-axis). Transmission line 50 may pass through opening 108 to feed arm 60.

Dielectric loading block 106 may dielectrically load the volume of antenna 40 between arm 60 and the portion of the antenna ground opposite and parallel to arm 60 (e.g., the vertical sidewalls of upper sheet metal 82 at side 94 as shown in FIG. 5). This may serve to widen the bandwidth of antenna 40 and/or may allow for reduction in the volume of antenna module 78 for a given bandwidth relative to implementations where dielectric loading block 106 is omitted. Since dielectric block 106 is not disposed between arm 60 and the aperture of antenna module 78, dielectric block 106 does not significantly block or introduce significant propagation loss to the radio-frequency signals conveyed by antenna 40. If desired, dielectric loading block 106 may fill the substantially all of the portion of cavity 112 between arm 60 and side 94 or may be omitted.

The remainder of cavity 112 may be filled with air if desired. An air-filled portion of cavity 112 may be laterally interposed between arm 60 and the aperture of antenna module 78 (e.g., dielectric layer 86). An air-filled portion of cavity 112 (e.g., having a thickness equal to distance 100) may be laterally interposed between dielectric loading block 106 or arm 60 and side 94 of antenna module 78. An air-filled portion of cavity 112 may be laterally interposed between arm 60 and the left side of antenna module 78. An air-filled portion of cavity 112 may be laterally interposed between arm 60 and the right side of antenna module 78. Alternatively, solid dielectric materials may be used to fill one or more of these portions.

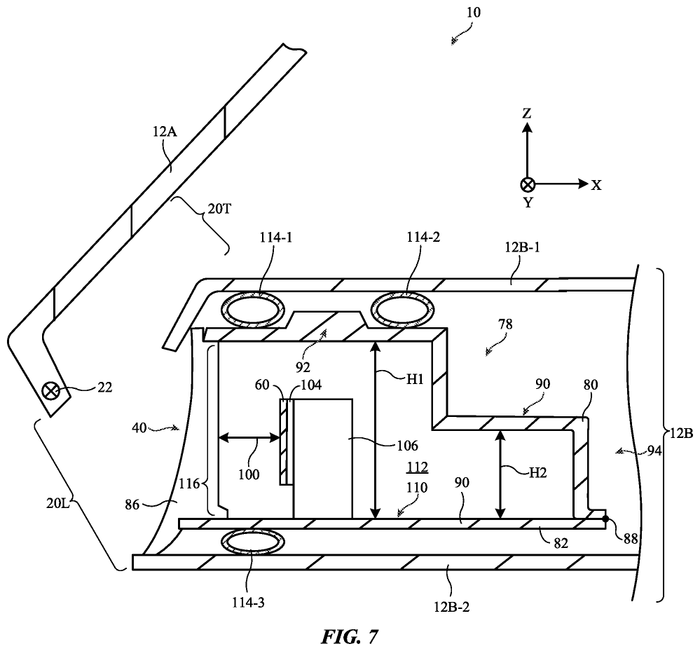

FIG. 7 is a cross-sectional side view showing how antenna module 78 may be mounted within lower housing 12B of device 10. As shown in FIG. 7, lower housing 12B may include a conductive upper wall 12B-1 and a conductive lower wall 12B-2. Lower housing 12B has an interior cavity between conductive upper wall 12B-1 and a conductive lower wall 12B-2. Antenna module 78 may be mounted along the rear edge of lower housing 12B between conductive upper wall 12B-1 and conductive lower wall 12B-2 (e.g., within the interior cavity of lower housing 12B).

When mounted within lower housing 12B, portion 92 and portion 90 of upper sheet metal 80 (e.g., one or more upper walls of antenna module 78) face conductive upper wall 12B-1 and lower sheet metal 82 faces conductive lower wall 12B-2. Upper sheet metal 80 is mounted to lower sheet metal 82 using welds 88. Cavity 112 is vertically interposed between upper sheet metal 80 and lower sheet metal 82. Cavity 112 is laterally interposed between side 94 and aperture 116. Cavity 112 is also laterally interposed along the Y-axis between the left side of upper sheet metal 80 and the right side of upper sheet metal 80 (e.g., as shown in FIG. 5). Upper sheet metal 80 and lower sheet metal 82 define conductive edges of cavity 112. Upper sheet metal 80 is folded (bent) to separate portion 92 from lower sheet metal 82 by a first height H1 and to separate portion 90 from lower sheet metal 82 by a second height H2 that is less than height H1. Upper sheet metal 80 is also folded to couple upper sheet metal 80 to lower sheet metal 82 at side 94. Welds 88 mechanically and electrically couple upper sheet metal 80 to lower sheet metal 82.

Height H1 may be sufficiently high so as to allow arm 60 and/or dielectric loading block 106 to be disposed within cavity 112. Height H2 may be sufficiently low so as to minimize the overall volume of antenna 78, thereby allowing additional room for other components to be mounted within device 10. If desired, the dimensions and shape of upper sheet metal 80 and lower sheet metal 82 may be selected to produce one or more electromagnetic resonant cavity modes for the response of antenna 40 that are excited by arm 60 (e.g., when cavity 112 forms part of the antenna resonating element for antenna 40).

Antenna module 78 has an aperture 116 facing the rear of lower housing 12B (e.g., an opening or slot that is free from conductive material such as upper sheet metal 80 and lower sheet metal 82). Aperture 116 is at the side of antenna module 78 opposite to side 94. Dielectric layer 86 covers aperture 116 to protect cavity 112 from dust, moisture, contaminants, and damage. Antenna 40 may convey radio-frequency signals through dielectric layer 86.

Dielectric loading block 106 and/or arm 60 may be mounted to lateral surface 110 of lower sheet metal 82 within cavity 112. Arm 60 is laterally interposed between dielectric loading block 106 and aperture 116. Arm 60 may be laterally separated from the interior surface of dielectric layer 86 by distance 100. Distance 100 may be selected to tune the overall response and/or performance of the antenna.

As shown in FIG. 7, the lateral surface of conductive upper wall 12B-1 may extend parallel or substantially parallel (e.g., within 30 degrees) to the lateral surface of conductive lower wall 12B-2. A main logic board, battery 36 (FIG. 2), a set of input-output devices 32, cooling system 38, transceiver circuitry 48, control circuitry 30, speaker 72, and other desired components (not shown in FIG. 7) may be mounted within the interior cavity of lower housing 12B. By mounting antenna module 78 in this way, an entirety of antenna 40 and antenna module 78 may be interposed between conductive upper wall 12B-1 and conductive lower wall 12B-2 within the interior of lower housing 12B. This may, for example, hide antenna 40 from view of a user at the exterior of device 10 and may protect antenna 40 from contaminants or damage.

Components such as keyboard 16 and track pad 18 (FIG. 1) may operate through openings in conductive upper wall 12B-1. Speaker ports 74 (FIG. 4) may also be formed in conductive upper wall 12B-1. Conductive lower wall 12B-2, which may be joined to conductive upper wall 12B-1 around the lateral periphery of lower housing 12B (e.g., such that conductive material surrounds the interior cavity and thus antenna module 78), may have feet or other support structures that allow device 10 to rest on a tabletop, a user's lap, or other support structure during operation.

Lower housing 12B may be separated from upper housing 12A by opening 20 of FIG. 4. Opening 20 may include a lower opening 20L between the conductive material of upper housing 12A and conductive lower wall 12B-2 of lower housing 12B (e.g., when upper housing 12A is in a closed-lid configuration) and/or may include both lower opening 20L and an upper opening 20T between the conductive material of upper housing 12A and conductive upper wall 12B-1 of lower housing 12B (e.g., when upper housing 12A is in an open lid configuration). Antenna 40 may convey radio-frequency signals through upper opening 20T and/or lower opening 20L.

Conductive upper wall 12B-1 may be electrically coupled to conductive lower wall 12B-2 through antenna module 78 and conductive gaskets 114. Conductive upper wall 12B-1, upper sheet metal 80, lower sheet metal 82, and conductive lower wall 12B-1 may all be held at a common ground potential using conductive gaskets 114. Conductive gaskets 114 may include, for example, a first conductive gasket 114-1 that couples upper sheet metal 80 to conductive upper wall 12B-1, an optional second conductive gasket 114-2 that couples upper sheet metal 80 to conductive upper wall 12B-1, and/or a third conductive gasket 114-3 that couples lower sheet metal 82 to conductive lower wall 12B-2. Upper sheet metal 80 is shorted to lower sheet metal 82 through welds 88. In this way, gaskets 114-1, 114-2, and 114-3 may help to extend the antenna ground for antenna 40 to also include conductive upper wall 12B-1 and conductive lower wall 12B-2. In addition, gaskets 114 may protect the interior cavity of lower housing 12B from dust, moisture, or other contaminants. Gaskets 114 may be formed from conductive foam, conductive fabric, adhesive, and/or other conductive structures (e.g., elastomeric structures that can expand outwardly against nearby structures after being compressed, air loop gaskets, etc.).

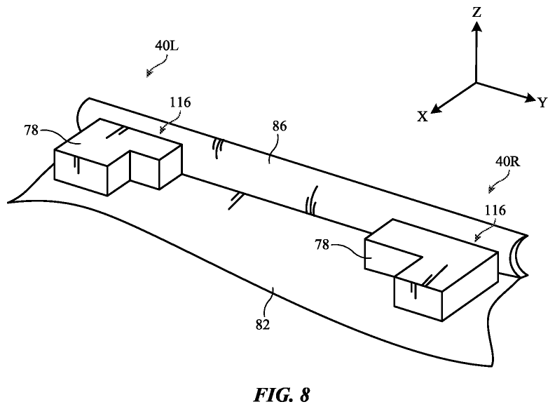

If desired, dielectric layer 86 may overlap multiple antenna modules 78 in device 10. FIG. 8 is an interior perspective view showing how dielectric layer 86 may overlap multiple antenna modules 78 in device 10. As shown in FIG. 8, device 10 may include a left antenna 40L that includes a first antenna module 78. Device 10 may also include a right antenna 40R that includes a second antenna module 78. The antenna modules may be mounted to surface 82 in the lower housing (e.g., adjacent respective speakers 72 as shown in FIG. 4). Dielectric layer 86 may overlap the aperture 116 of the antenna module 78 for left antenna 40L and may overlap the aperture 116 of the antenna module 78 for right antenna 40R. Dielectric layer 86 may also prevent moisture, dirt, or other contaminants from passing into the interior of device 10.

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made by those skilled in the art without departing from the scope and spirit of the described embodiments. The foregoing embodiments may be implemented individually or in any combination.

What is claimed is:

1. A laptop computer comprising:
a lower housing that includes an upper metal wall and a lower metal wall;
an upper housing coupled to the lower housing by a hinge, the upper housing including a display;
a first piece of sheet metal between the upper metal wall and the lower metal wall;
a second piece of sheet metal between the first piece of sheet metal and the upper metal wall, wherein the second piece of sheet metal is folded and welded to the first piece of sheet metal, the first and second pieces of sheet metal define a cavity having an aperture, and the aperture faces a slot between the upper housing and the lower housing;
a dielectric layer that covers the aperture; and
an antenna arm disposed within the cavity and configured to radiate through the aperture and the dielectric layer, wherein the antenna arm is separated from the dielectric layer by a non-zero distance.

2. The laptop computer of claim 1, wherein the antenna arm is mounted to a lateral surface of the first piece of sheet metal.

3. The laptop computer of claim 2, further comprising a return path that couples the antenna arm to the lateral surface of the first piece of sheet metal.

4. The laptop computer of claim 3, further comprising:
a third piece of sheet metal that includes the antenna arm and the return path.

5. The laptop computer of claim 4, further comprising:
a dielectric block mounted to the lateral surface of the first piece of sheet metal, the antenna arm being laterally interposed between the dielectric block and the dielectric layer.

6. The laptop computer of claim 5, wherein the cavity comprises air between the antenna arm and the dielectric layer.

7. The laptop computer of claim 5, further comprising:
a layer of adhesive that couples the third piece of sheet metal to the dielectric block.

8. The laptop computer of claim 7, further comprising:
a tunnel in the dielectric block; and
a coaxial cable that extends through the tunnel and that is coupled to the antenna arm at an antenna feed terminal.

9. The laptop computer of claim 1, wherein a lateral surface of the antenna arm is orthogonal to a lateral surface of the first piece of sheet metal.

10. The laptop computer of claim 1, wherein the second piece of sheet metal has a first portion separated from the first piece of sheet metal by a first height, the second piece of sheet metal has a second portion separated from the first piece of sheet metal by a second height less than the first height, the first portion is laterally interposed between the second portion and the dielectric layer, and the antenna arm is interposed between the first portion and the first piece of sheet metal.

11. The laptop computer of claim 10, further comprising:
a first conductive gasket that couples the first portion of the second piece of sheet metal to the upper metal wall; and
a second conductive gasket that couples the first piece of sheet metal to the lower metal wall.

12. The laptop computer of claim 1, further comprising:
a third piece of sheet metal between the upper metal wall and the lower metal wall;
a fourth piece of sheet metal between the third piece of sheet metal and the upper metal wall, wherein the fourth piece of sheet metal is folded and welded to the third piece of sheet metal, the third and fourth pieces of sheet metal define an additional cavity having an additional aperture, the additional aperture faces the slot between the upper housing and the lower housing, and the dielectric layer covers the additional aperture; and
an additional antenna arm disposed within the additional cavity and configured to radiate through the additional aperture and the dielectric layer, wherein the additional antenna arm is separated from the dielectric layer by the non-zero distance.

13. A laptop computer comprising:
a lower housing that includes an upper metal wall and a lower metal wall;
an upper housing coupled to the lower housing by a hinge, the upper housing including a display;
sheet metal mounted between the upper metal wall and the lower metal wall, wherein the sheet metal defines a cavity, the sheet metal includes a first wall and a second wall at opposing sides of the cavity, the cavity has an aperture facing a slot between the upper housing and the lower housing, and the first wall is bent towards and coupled to the second wall at a side of the cavity opposite the aperture;
a dielectric layer that covers the aperture;
a dielectric block in the cavity and mounted to the second wall; and
an antenna resonating element within the cavity and mounted to a side of the dielectric block facing the aperture, wherein the antenna resonating element is configured to convey radio-frequency signals through the aperture and the dielectric layer.

14. The laptop computer of claim 13, wherein the sheet metal comprises a first piece of sheet metal that includes the first wall and a second piece of sheet metal that includes the second wall, the first piece of sheet metal being welded to the second piece of sheet metal at the side of the cavity opposite the aperture.

15. The laptop computer of claim 13, wherein the first wall has a first portion separated from the second wall by a first height and has a second portion separated from the second wall by a second height less than the first height, the antenna resonating element being interposed between the second wall and the first portion of the first wall.

16. The laptop computer of claim 13, wherein the cavity comprises air between the antenna resonating element and the dielectric layer.

17. The laptop computer of claim 13, wherein the second wall is planar and the antenna resonating element is orthogonal to the second wall.

18. The laptop computer of claim 17, further comprising:
a hole in the dielectric block;
a coaxial cable that extends along the second wall and through the hole, the coaxial cable being coupled to an antenna feed terminal on the antenna resonating element;
additional sheet metal mounted between the upper metal wall and the lower metal wall, wherein the additional sheet metal defines an additional cavity, the additional sheet metal includes a third wall and a fourth wall at opposing sides of the additional cavity, the additional cavity has an additional aperture facing the slot between the upper housing and the lower housing, the third wall is bent towards and coupled to the fourth wall at a side of the additional cavity opposite the additional aperture, and the dielectric layer covers the additional aperture;
an additional dielectric block in the additional cavity and mounted to the fourth wall; and
an additional antenna resonating element within the additional cavity and mounted to a side of the additional dielectric block facing the additional aperture.

19. A laptop computer comprising:
a lower housing that includes an upper metal wall and a lower metal wall;
an upper housing coupled to the lower housing by a hinge, the upper housing including a display;
a first piece of sheet metal;
a second piece of sheet metal bent towards the first piece of sheet metal, wherein a cavity is interposed between the first and second pieces of sheet metal, the cavity has an aperture, and the second piece of sheet metal is coupled to the first piece of sheet metal at a side of the cavity opposite the aperture;
a dielectric layer that covers the aperture;
a third piece of sheet metal within the cavity and mounted to the first piece of sheet metal; and
a radio-frequency transmission line coupled to the third piece of sheet metal within the cavity, the third piece of sheet metal being configured to radiate through the aperture and the dielectric layer.

20. The laptop computer of claim 19, wherein the third piece of sheet metal is orthogonal to the first piece of sheet metal and is separated from the dielectric layer by a non-zero distance.
